(19) United States
(12) Patent Application Publication
(10) Pub. No.: US 2012/0074173 A1
(43) Pub. Date: Mar. 29, 2012

(54) BOTTLE WITH DRINKING RESERVOIR AND PUMP

(76) Inventor: Blake Vanier, Boulder, CO (US)

(21) Appl. No.: 13/245,803

(22) Filed: Sep. 26, 2011

Related U.S. Application Data
(60) Provisional application No. 61/404,013, filed on Sep. 24, 2010.

(51) Int. Cl. B65D 37/00; B65D 83/00; B67D 7/06

(52) U.S. Cl. 222/209; 222/401; 222/205

(57) ABSTRACT

An insulated container for liquids having a lower chamber sealed with a lid, such lid having a reservoir for holding liquid which is pumped from the lower chamber through a dispensing passage. The pump may be an air or water pump of a variety of styles, but it is designed to be operated by a single finger on the same hand that holds the container. This pump may be placed on the lid, such that the lid may be placed on alternate lower chambers. The pump may also be made with a button or soft membrane.

### CROSS REFERENCE TO RELATED APPLICATIONS

This application claims the benefit of U.S. Provisional Application No. 61/404,013, filed Sep. 4, 2010.

### FEDERALLY SPONSORED RESEARCH

Not Applicable

### SEQUENCE LISTING OR PROGRAM

Not Applicable

### BACKGROUND OF THE INVENTION

1. Field of the Invention

The present invention pertains to the field of liquid containers. More particularly, the present invention pertains to the field of containers that help maintain the liquid's temperature and allow for easy consumption.

2. Description of Related Art

Conventional closed liquid containers: often called bottles, cups, mugs, coffee cups, thermoses, etc. . . . only allow easy access to the main reservoir of liquid. In the case of a liquid desired at an elevated temperature, this causes sonic problems. When considering a standard cup or bottle, one must wait until the liquid cools to a safe temperature before consuming. This waiting is also accompanied by frequent testing of the liquid to determine its temperature either by tasting it from the container and risking a burn, or pouring the liquid out and letting it cool in the air to the desired temperature. When the liquid reaches the desired consumption temperature a window of opportunity is then opened when the liquid must be consumed before it drops below such temperature. If the mug is not insulated, this window of time may be quite short. In the case of an insulated mug or container, the window of time to consume the liquid is much larger; however, the insulating properties of the container can also make it difficult to judge when the liquid is at a safe temperature to consume and will prolong the time taken for the liquid to reach the desired temperature, both of which problems are well-known to those who drink hot beverages.

3. Objects and Advantages

None of the particular objects or advantages that follow must be entirely satisfied as they are non-exclusive alternatives and at least one of the following objects is met; accordingly, several objects and advantages of the present invention are:

(a) to provide an insulated bottle with a lid that contains a reservoir for the containment of liquid that is open to the air;

(b) to provide a means for pumping liquid from the inside of a bottle to a reservoir that is open to the air on the lid of a bottle;

(c) to provide a means for pumping liquid from a bottle to a reservoir that is open to the air on the lid of a bottle, such pumping means being a part of the lid of the bottle;

(d) to provide a means for pumping liquid from a bottle to a reservoir that is open to the air on the lid of a bottle that is conveniently operated with a single finger on the hand that holds the bottle;

(e) to provide a means for pumping liquid from a bottle to a reservoir that is open to the air on the lid of a bottle that is durable, flexible, and texturally appealing to the finger;

(f) to provide a means for pumping liquid from a bottle to a reservoir that is open to the air on the lid of a bottle that is streamlined and will not catch on other objects;

(g) to provide a means for pumping liquid from a bottle to a reservoir that is open to the air on the lid of a bottle that is easy to produce;

(h) to provide a means for pumping liquid from a bottle to a reservoir that is open to the air on the lid of a bottle that is easy to disassemble and clean;

(i) to provide a means for pumping liquid from a bottle to a reservoir that is open to the air on the lid of a bottle that is easy to fix or replace;

(j) to provide a means for pumping liquid from a bottle to a reservoir that is open to the air on the lid of a bottle that is durable and unlikely to break;

(k) to provide a means for pumping liquid from a bottle to a reservoir that can be conveniently opened and closed to prevent unwanted liquid from pouring from the bottle to the reservoir;

(l) to provide a means for pumping liquid from a bottle to a reservoir that prevents unwanted splash back toward the User;

(m) these and other objectives and advantages of the instant invention will become apparent from the following description taken in conjunction with the accompanying drawings wherein are set forth, by way of illustration and example, certain embodiments of the instant invention. The drawings constitute a part of this specification and include exemplary embodiments of the present invention and illustrate various objects and features thereof.

### 1. FIGURES

FIG. 1 illustrates a cross-section view of a simplified illustration of bottle with a reservoir, a pump, and a lid with a reservoir open to the air.

FIGS. 2(a) and 2(b) illustrate a cross-section view and a perspective view, respectively, of a bottle with a finger operated air pump on the lid.

FIG. 3 illustrates a detailed cross-section view of an air pump on the lid of a bottle.

FIG. 4 illustrates a cross-section view of a liquid pump embodiment of the present invention.

FIG. 5(a), 5(b), and 5(c) illustrate perspective views of a bottle with side actuated, trigger actuated, and bottom actuated pumps respectively,

FIG. 6 illustrates two perspective views of a bottle with a membrane pump and sealing mechanism.

FIG. 7 illustrates a cross-section of a bottle with a membrane pump and sealing mechanism.

FIG. 8(a) illustrates a cutaway cross-section of an open sealing mechanism on a liquid exit to a reservoir on the lid of a bottle.

FIG. 8(b) illustrates a cutaway cross-section of a closed sealing mechanism on a liquid exit to a reservoir on the lid of a bottle.

### 2. REFERENCES

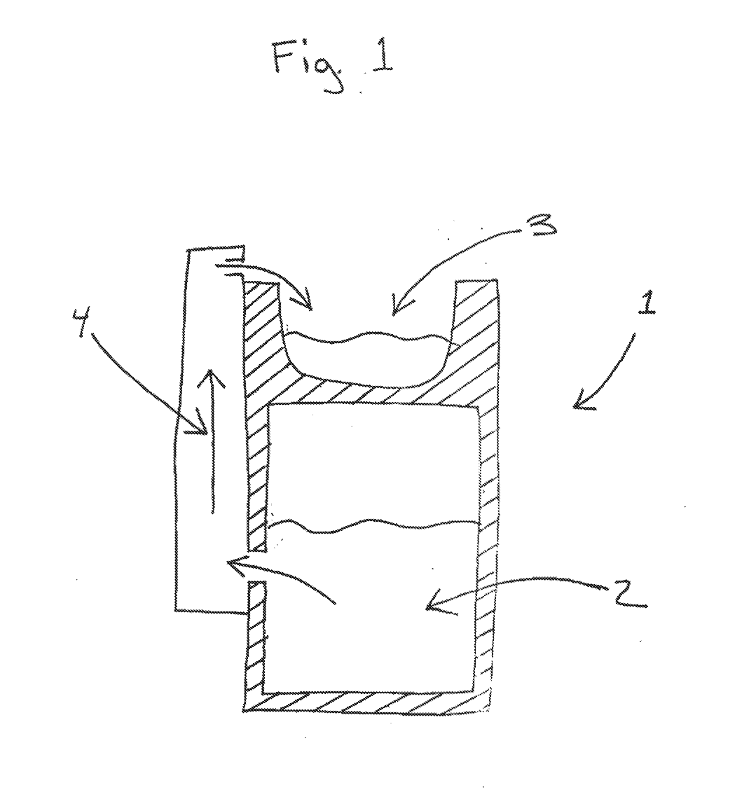

### FIG. 1

1. Container
2. Holding reservoir
3. Drinking reservoir
4. Pump mechanism

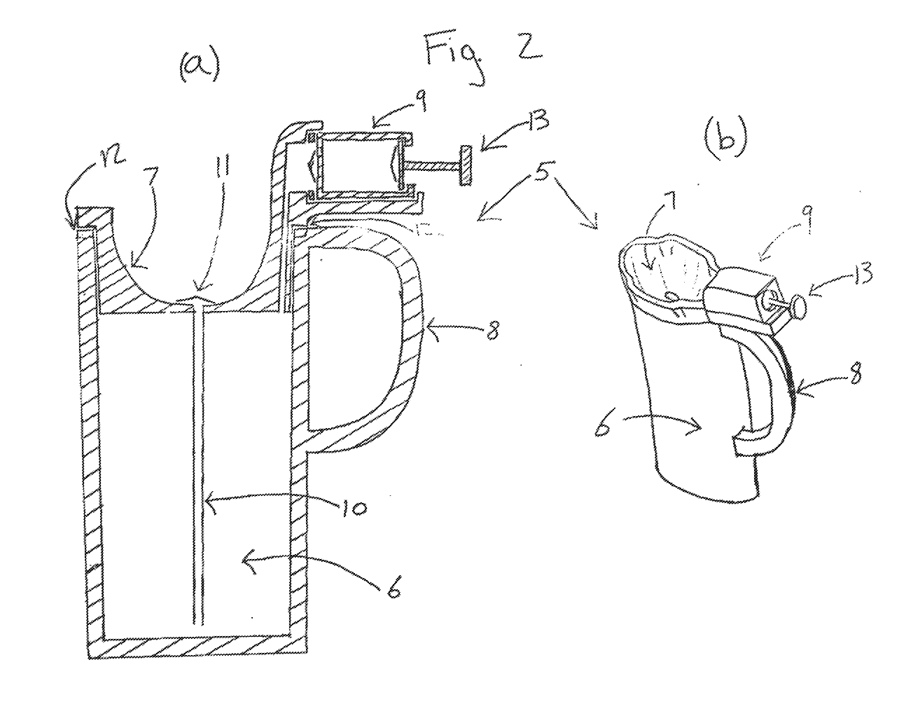

### FIG. 2

5. Container
6. Holding reservoir
7. Drinking reservoir
8. Handle
9. Air pump
10. Removable liquid tube
11. Valve
12. Seal
13. Air pump actuator

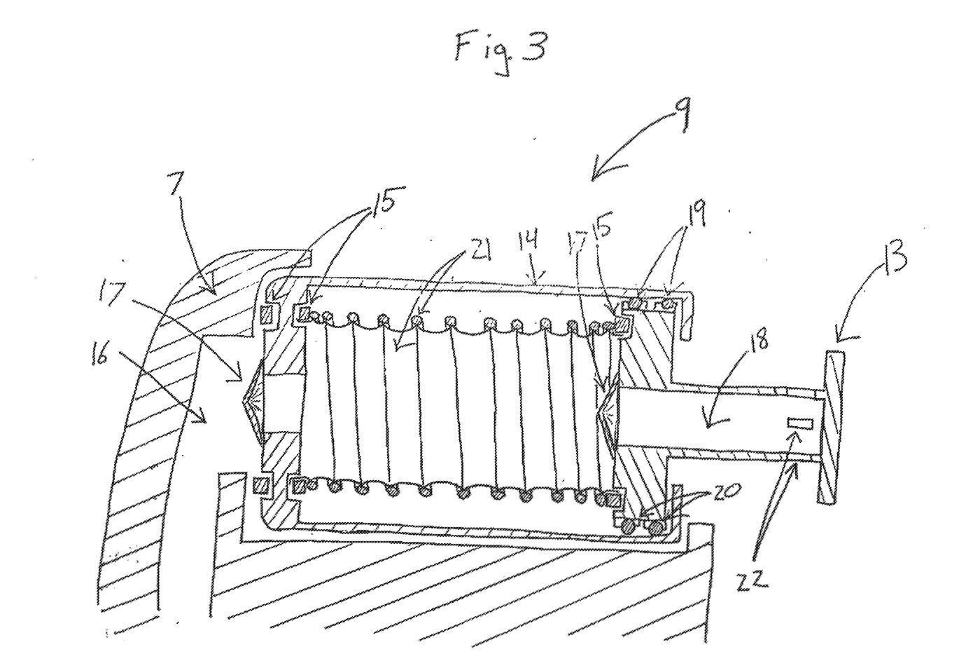

### FIG. 3

14. Air pump casing
15. Sealing rings
16. Exit air channel
17. Air valves
18. Entrance air channel
19. Rolling balls
20. Rolling bail holders
21. Return spring with a flexible membrane
22. Entrance air slits

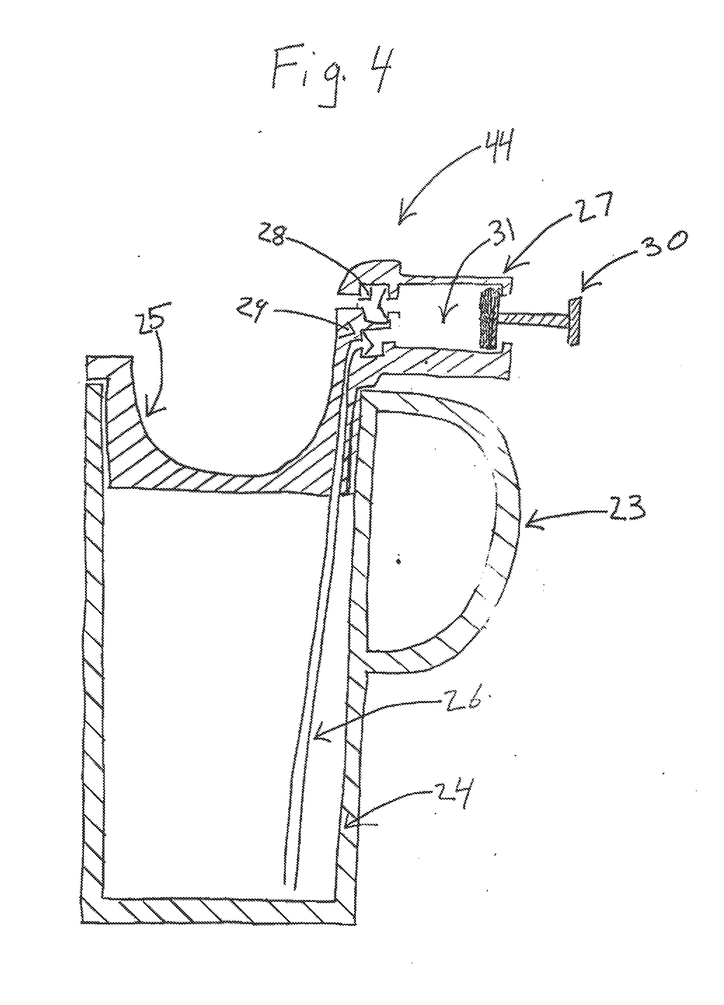

### FIG. 4

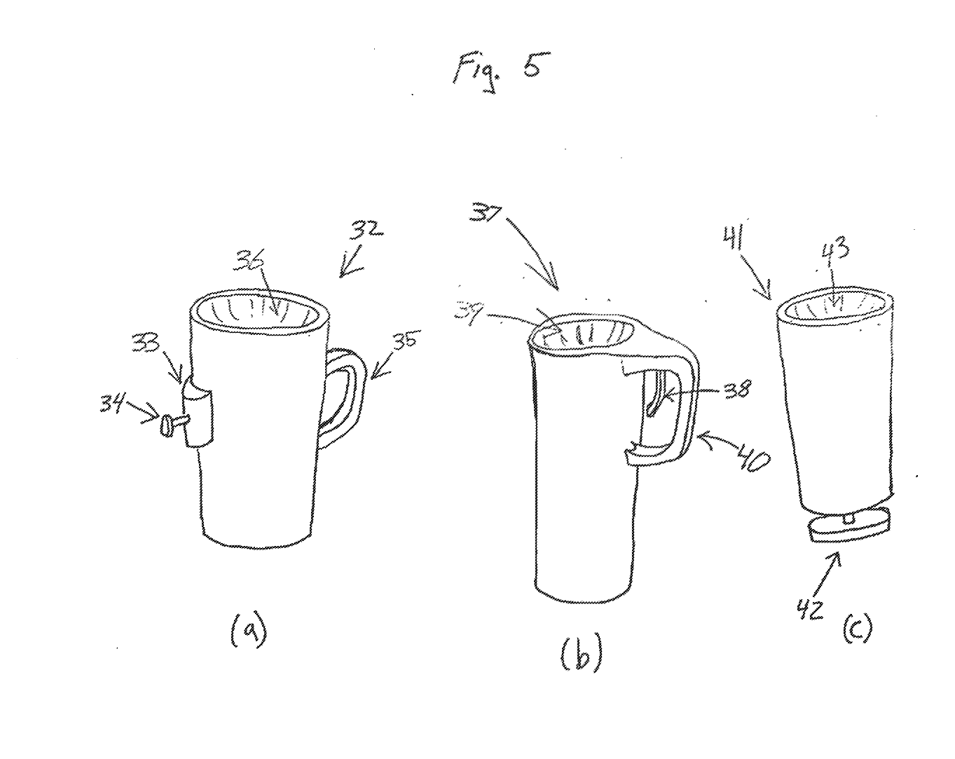

23. Handle
24. Holding reservoir
25. Drinking reservoir
26. Removable liquid tube
27. Liquid pump
28. Liquid out valve
29. Liquid in valve
30. Liquid pump actuator
31. Liquid pump reservoir
   FIG. 5(a)
32. Container
33. Side positioned pump
34. Pump actuator
35. Stabilizing feature
36. Drinking reservoir
   FIG. 5(b)
37. Container
38. Trigger actuator
39. Drinking reservoir
40. Handle
   FIG. 5(c)
41. Container
42. Bottom positioned actuator
43. Drinking reservoir

### FIG. 4 (Orphan)

44. Container

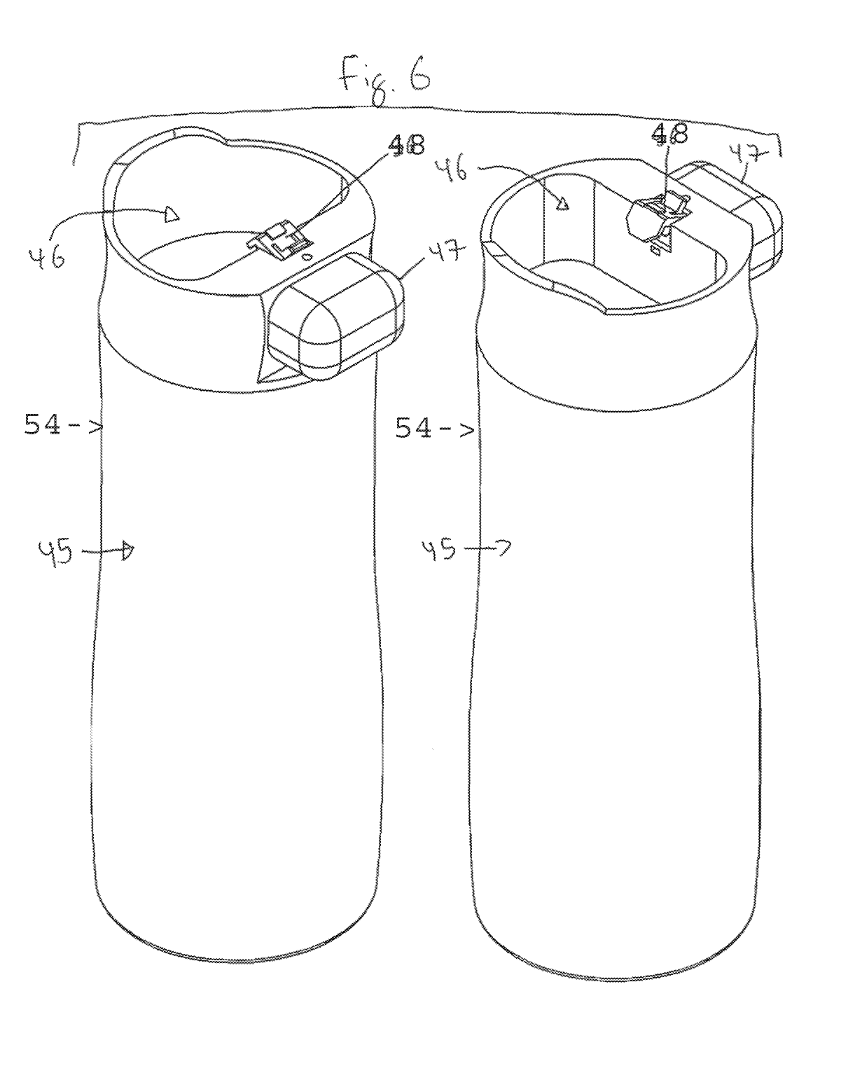

### FIG. 6

45. Holding reservoir
46. Drinking reservoir and cap
47. Membrane pump
48. Liquid spout

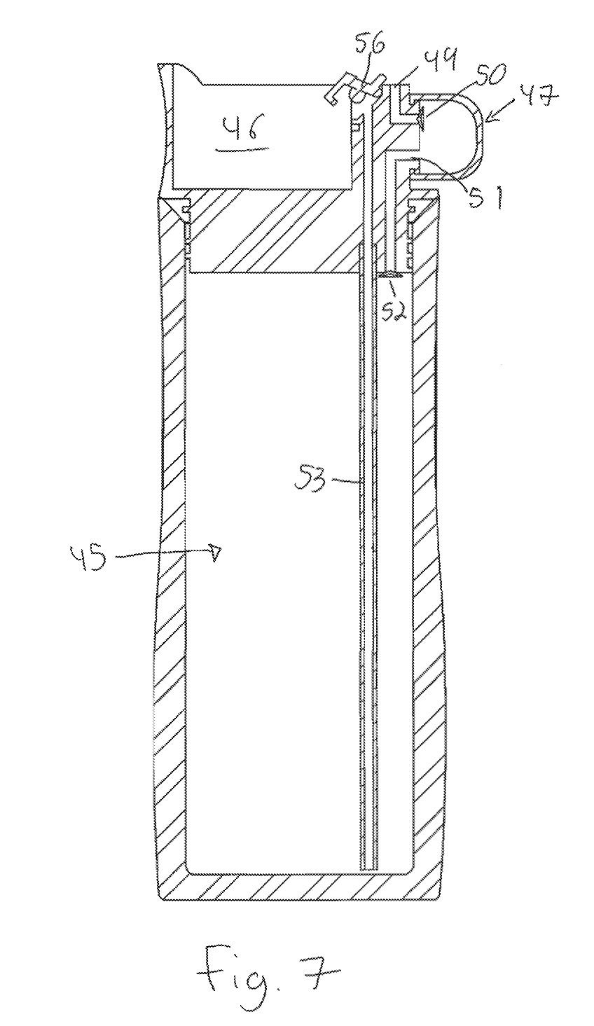

### FIG. 7

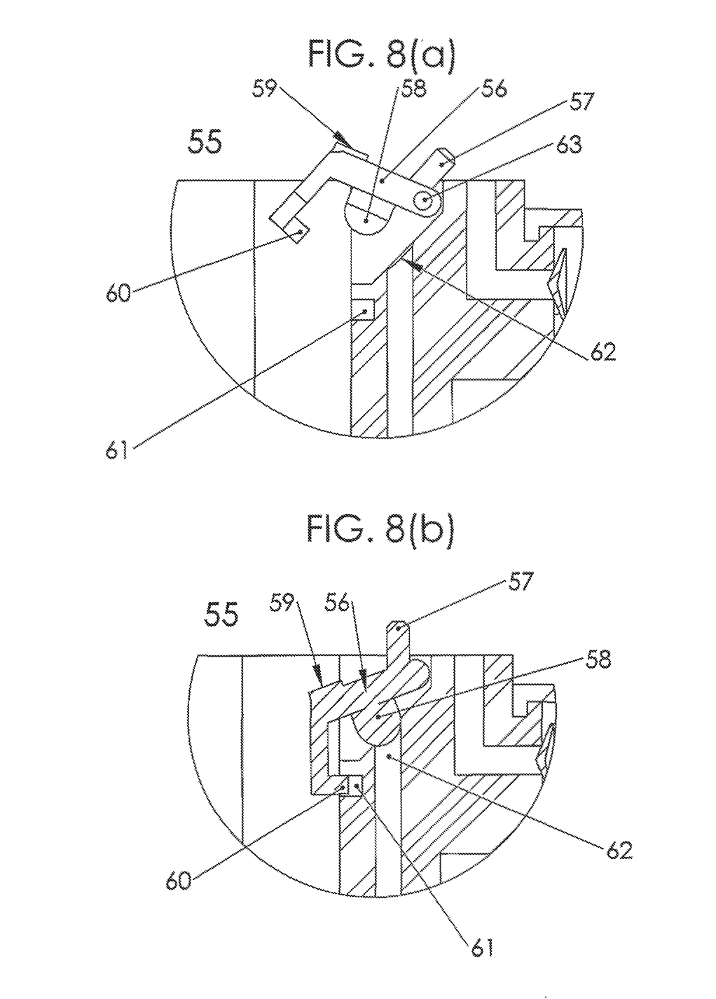

49. Pump air inlet
50. Pump air inlet valve
51. Pump air outlet
52. Pump air outlet valve
51. Removable liquid tube
54. Container for FIG. 6 and FIG. 7
   FIG. 8(a)
55. Container sealing latch
56. Closing flap
57. Opening lever
58. Sealing valve
59. Closing push point
60. Closing flap latch
61. Lid latch point
62. Liquid exit
63. Closing flap pivot point

### DETAILED DESCRIPTION OF THE INVENTION

For the purposes of promoting an understanding of the principles of the invention, reference will now be made to the embodiments illustrated in the drawings and specific language will be used to describe the same. However, the illustrated embodiments are merely exemplary and many additional embodiments of this invention are possible. For example, bottles are pictured; however, this invention can be applied to most cups and mugs. It is understood that no limitation of the scope of the invention is thereby intended. Any alterations and further modifications in the illustrated devices, and such further application of the principles of the invention as illustrated herein are contemplated as would normally occur to one skilled in the art to which the invention relates.

Shown throughout the figures, the instant invention is generally directed toward a small cup shaped lid which either has a pump or is facilitated by a pump for the purpose of pumping liquid from the inside of a bottle to a reservoir on the lid. First will be a description of the significant features of this invention with reference to the appended drawings.

Shown in FIG. 1 is a simplified illustration of a cross-section view of a container (1) with a larger, holding reservoir (2), a smaller, drinking reservoir (3) and a pump mechanism (4). The holding reservoir (2) is used to store the bulk of the liquid. When the User desires, the User will use the accompanied pump mechanism (4) to move the liquid into the drinking reservoir (3). Once the liquid is in the drinking reservoir (3), they may consume the liquid when it meets their specific preferences.

in further detail, the holding reservoir (2) is of a size to hold an amount of liquid adequate for an individual consuming their beverage of choice. The size of the holding reservoir is not limited, but may be capable of holding around 8-32 ounces. Likewise, the drinking reservoir (3) must be of adequate size to meet the consumer's needs; and again, it is not limited to, but may be capable of holding around 1-4 ounces of liquid safely without risk of spilling. The drinking reservoir (3) may have a means for the user to consume the liquid easily, such as: a lip, spout, straw, or any other device that serves a similar function. The pump mechanism (4) is of adequate size to move the liquid from the larger reservoir (2) to the drinking reservoir (3) with a reasonable amount of effort by the User. The User should be able to move the desired amount of liquid to the drinking reservoir (3) with around 1-6 pumps of the mechanism.

The holding reservoir (2) is not limited to this shape and may be of any shape that meets a User's demands, such as: as bag, a box, or other shaped container. The holding reservoir (2) may have insulating properties to keep the liquid at a stable temperature but this is not necessary. The drinking reservoir (3) is not limited to the top of the lid as illustrated by the simplified embodiment in FIG. 1. It may be on the side, bottom, or in any other location that would allow the User to consume the liquid. In this case, the drinking reservoir (3) and the holding reservoir (2) are made as two parts to one container; however, this is not necessary, they may be of any number of parts to meet the needs of an embodiment of the present invention. One possible embodiment would use the drinking reservoir (3) as a lid for the holding reservoir (2), which is discussed in the next figure.

The holding reservoir (2) and the drinking reservoir (3) may be constructed of any suitable material, such as glass, plastic, or metal. The pump mechanism (4) may be any mechanism that moves the liquid from the holding reservoir to the drinking reservoir (3). This may include, but is not limited to: an air pump that pressurizes the holding reservoir (2) and in turn forces a liquid to the drinking reservoir (3), or a liquid pump that pumps the liquid directly from the holding reservoir (2) to the drinking reservoir (3). Each of these will be discussed in greater detail below. While it is called a pump herein, it may also be a process that satisfies these needs, such examples would be: tilting the container (1) so that the drinking reservoir (3) fills up, or even a swirling motion that forces the liquid through a process that moves the liquid to the drinking reservoir (2).

1. Embodiment with Air Pump

Shown in FIG. 2(a) is a detailed view of a cross-section of a container (5), a holding reservoir (6), a drinking reservoir (7), a handle (8), an air pump (9), a liquid tube (10), a valve (11), a seal (12), and an air pump actuator (13). Shown in FIG. 2(b) is a perspective view of this same embodiment with the holding reservoir (6), drinking reservoir (7), handle (8), air pump (9) and air pump actuator (13).

The details of the holding reservoir (6) and the drinking reservoir (7) are similar to those discussed in FIG. 1; however, in this embodiment they are two parts: where the drinking reservoir (7) acts as a lid to contain the liquid in the holding reservoir (6). A circular seal (12) separates the two parts and prevents liquid from leaking out of the container (5). The holding reservoir (6) and the drinking reservoir (7) may be held together by any means, one possibility may be threaded surfaces. The overall size of container (5) may be of a similar size to other containers holding a similar amount of liquid. The handle (8) is not limited to this shape or form and may be of any design to help the User hold the container (5) while in use. The handle (8) may not even be used if stability of the container (5) is not a concern.

In this embodiment, the air pump (9) is operated by the User, using the air pump actuator (13) which increases the pressure in the holding reservoir (6). The increase in pressure, forces liquid up the liquid tube (10) and past a valve (11) where it then collects in the drinking reservoir (7). The valve (11) prevents the liquid from flowing back down to the holding reservoir (6). The details of the air pump (9) will be discussed in further detail in the next figure, FIG. 3. The materials of these components may be of anything that satisfies the needed requirements for operation, such as a metal, plastic, and rubber.

The configuration of these components is not restricted to what is shown in this preferred embodiment of FIG. 2. Variations of this design could incorporate a curved or circular liquid tube instead of the straight liquid tube (10); preventing free flow of the liquid from the container (5) if it is knocked over. The liquid from the large reservoir (6) does not have to enter the drinking reservoir (7) from the bottom, but may come out from the side or any other location that allows the liquid to eventually settle in the drinking reservoir (7). Variation in the air pump (9) location and the air pump actuator (13) will be discussed after a further description of the air pump (9) and a description of a liquid pump embodiment.

Shown in FIG. 3 is a more detailed cross-section view of an air pump (9), a air pump actuator (13), an edge of a drinking reservoir (7), an air pump casing (14), sealing rings (15), an exit air channel (16), air valves (17), an entrance air channel (18), rolling balls (19), rolling ball holders (20), a return spring with a flexible membrane (21), and entrance air slits (22).

As shown in FIG. 3, with the exception of the drinking reservoir (7), the air pump casing (14), the rolling balls (19), and the rolling ball holders (20), each of these components are cylindrically symmetric about the cross-section view. The entrance air channel (18) is made up of a hollow tube in the center of the air pump actuator (13).

The air pump casing (14) secures the components of the air pump (9) and rests in a latched position at the top of the drinking reservoir (7) as shown in FIG. 2. The User presses the air pump actuator (13) into the air pump (9). As the air pump actuator (13) plunges into the air pump (9) a return spring with a flexible membrane (21) in the center of the air pump (9) is compressed, forcing air through an air valve (17) into the exit air channel (16). Each of the air valves (18) are secured in such a way that they only allow air to pass in one direction. Once the air pump (9) has been compressed to deliver the appropriate amount of liquid, the User releases pressure on the air pump actuator (13) and the return spring with a flexible membrane (21) pushes the air pump actuator (13) into its resting position. This expands the flexible membrane attached to the spring, creating a low pressure zone. The pressure gradient pulls air through the air valve (17) at the entrance air channel (18) through air slits (22) at the base of the push location of the air pump actuator (13). Sealing rings (15) at the locations shown insure an air tight seal and rolling balls (19), secured by rolling ball holders (20), allow the air pump actuator (13) to move smoothly through the air pump casing (14).

In the embodiment the air pump (9) in FIG. 3, the air pump is a separate component from the drinking reservoir (7). This allows for easy separation of the more complicated parts and facilitates cleaning of the fluid reservoirs; however, this is not a requirement for this invention and is only one embodiment. Furthermore, any mechanism that acts to change the volume of the large reservoir (6), which then forces liquid to the drinking reservoir (7), is in accordance with the present invention. This embodiment is not intended to limit the scope of the present invention. It is purely an example of the component arrangements possible in accordance with the present invention.

2. Embodiment with Liquid Pump

Shown in FIG. 4 is a cross-section of another example of the present invention using a liquid pump. FIG. 4 comprises a container (44), a handle (23), a holding reservoir (24), a drinking reservoir (25), a removable liquid tube (26), a liquid pump (27), a liquid out valve (28), A liquid in valve (29), a liquid pump actuator (30), and a liquid pump reservoir (31). Many of the concepts in this embodiment are similar to that of the embodiment in FIG. 3. The main difference is that the liquid pump (27) is now pulling liquid through the removable liquid tube (26), through the liquid in valve (29), into the liquid pump reservoir (31); which is then pumped out of the liquid out valve (28) and into the drinking reservoir (25). In this embodiment there will be liquid stored in the pumping reservoir (31) between pump cycles. The design principles of the air pump (9) from the previous embodiment can be applied to the design of the liquid pump (27), to create a comparable device with the different pumping processes.

### 3. Pump Location and Actuator Variations

The embodiments of FIG. 3 and FIG. 4 show a pump location at the top, most likely actuated by a User's thumb; however, there are many other such combinations that would be in accordance with this invention. Shown in FIG. 5(a) is a container (32), a side positioned pump (33), a pump actuator (34), a stabilizing feature (35), and a drinking reservoir (36). In this embodiment the pump actuator (34) may be operated by the User's fingers with their thumb using the stabilizing feature (35) to steady the container (32). The pump (33) could be external as shown, or internal to provide a more sleek design. The pump actuator (34) is not limited to this design and may be a lever or some feature that allows the user to squeeze the container to actuate.

Shown in FIG. 5 (b) is a container (37), a trigger actuator (38), a drinking reservoir (39), and a handle (40). In this embodiment, the mechanism for moving the liquid to the drinking reservoir (39) would be actuated by a trigger like mechanism. The user may hold the container (37) by the handle (40), and use the trigger actuator (38) to move the liquid to the drinking reservoir (39). The mechanism that actually does the moving of the liquid could be in any location that optimized the design for this embodiment.

Shown in FIG. 5 (c) is a container (41), a bottom positioned actuator (42), and a drinking reservoir (43). In this embodiment, the mechanism for moving the liquid to the drinking reservoir (43) would be operated by a bottom positioned actuator (42). The bottom positioned actuator (42), would move up and down to operate the mechanism for moving the liquid to the drinking reservoir (43).

4. Embodiment with Membrane Air Pump

Shown in FIG. 6 is a perspective view of an embodiment of the present invention of a container comprising: a holding reservoir (45), a drinking reservoir and cap (46), a membrane pump (47), and a liquid spout (48).

Shown in FIG. 7 is a detailed view of the cross section of the same embodiment (44): the holding reservoir (45), the drinking reservoir and cap (46), the membrane pump (47), the liquid spout (48), a pump air inlet (49), a pump air inlet valve (50), a pump air outlet (51), a pump air outlet valve (52), and a removable liquid tube (53).

The details of this embodiment are similar to the embodiment in FIG. 2; however, this design uses a flexible pump membrane (47) to provide the pumping action required for the present invention. The pump membrane (47) may be constructed out of rubber, a flexible polymer, or any other material that would provide the proper functionality. When the User desires, the User will depress the pump membrane (47), which causes a positive pressure that is forced down the pump outlet (51) and through the pump outlet valve (52) which causes an increase in pressure in the holding reservoir (45) forcing liquid up the removable liquid tube (53) and out the liquid spout (48). The liquid is then collected in the drinking reservoir (46). Once the User removes pressure from the pump membrane (47), the pump membrane (47) retakes its original form. This causes a negative pressure in the pump membrane (47), which activates the pump air inlet valve (50), allowing air to pass through the pump air inlet (49). The inflow of air from the pump air inlet (49) fills the pump membrane (47) and equalizes the pressure gradient. Once one cycle is complete, the User may repeat until the desired amount of liquid has filled the drinking reservoir (46).

Shown in FIG. 8(a) is a detailed cutaway cross-section view an alternate spout configuration, the container sealing latch (55), for the container (54) shown in FIG. 6. In this figure there is a closing flap (56), an opening lever (57), a sealing valve (58), a closing push point (59), a closing flap latch (60), a lid latch point (61), a liquid exit (62), and a closing flap pivot point (63).

The purpose of the container sealing latch (55), is to seal the liquid exit (62), while also providing a means to deflect incoming liquid coming from the liquid exit (62) from hitting the User. When the User desires to close the container (54), the user will push down on the closing push point (59) which will push the sealing valve (58) into the liquid exit (62), and the closing flap latch (60) into the lid latch point (61). The closing flap latch (60) will hold the closing flap in place and insure a seal between the sealing valve (58) and the liquid exit (62). When the User desires to use the container (54), the User will push on the opening lever (57) which will release the closing flap latch (60) from the lid latch point (61) which will break the seal of the sealing valve (58) and the liquid exit (62), allowing liquid to come up freely. In this configuration, the closing flap (60) should also provide an adequate amount of protection so that the liquid from the liquid exit point (62) will be channeled into the drinking reservoir and cap (46) without splashing the User. During the opening and closing cycles of the container sealing latch (55), the closing flap (56) will pivot about the closing flap pivot point (63).

The materials of this container sealing flap (55) will be that of anything that will provide the proper rigidity and flexibility to perform the desired action, which will most likely be a plastic or a metal. The sealing valve (58) will be of a more flexible material that will allow for the desired seal to be made around the liquid exit (62), which will most likely be some sort of rubber or flexible polymer

Shown in FIG. 8(b) is the same detail as FIG. 8(a); except in the closed configuration. Shown is the container sealing latch (55), the closing flap (56), the opening lever (57), the sealing valve (58), the closing push point (59), the closing flap latch (60), the lid latch point (61), and the liquid exit (62). It can be seen that the closing flap latch (60) is in the lid latch point (61) and the sealing valve (58) is sealed against the liquid exit (62).

A couple of advantages of the present invention are that it would minimize risk of spilling the bulk of a liquid contained while still maintaining a means to easily consume the liquid, and in the use case of consuming a heated beverage, this invention provides an easy means of only cooling a small amount of the liquid at a time, allowing the bulk of the liquid to stay hot longer. An insulated version of this invention would provide a container that would be able to keep a liquid hot for an extended amount of time but have the easy drinkability of a simple mug or other container.

In a general embodiment, the present invention is a container with a large reservoir for containing the bulk of a liquid, a smaller reservoir for short term storage and consumption, and a mechanism and or process that moves the liquid from the large reservoir to the smaller, drinking reservoir. It is contemplated that the use of a membrane air pump will greatly simplify the devise, reducing the parts necessary for its operation, its ease of use, and ease of cleaning. The membrane pump contains less moving parts, can be smaller, less likely to catch on other objects, and is less likely to break. It is also contemplated that having the pump mounted on the lid will have the advantage of placing it in closer proximity to the fingers allowing for single handed operation, and allow for easy replacement of the lid with fill pumping functionality from one holding reservoir, or cup, to another. Easy removal of the pumping mechanism, such as a membrane pump (47), and of the liquid tube (26) will allow the devise to be packing into smaller spaces, using less cabinet space.

It is to be understood that while certain forms of the invention are illustrated, it is not to be limited to the specific forms or arrangements herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantage mentioned, as well as those inherent therein. The embodiments, methods, procedures, and techniques described herein are presently representative of the preferred embodiments; are intended to be exemplary; and are not intended as limitations on the scope. Changes therein and other uses will occur to those skilled in the art which are encompassed within the spirit of the invention and are defined by the scope of the claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the claims.

### REFERENCE TO SEQUENCE LISTING, A TABLE, OR A COMPUTER PROGRAM LISTING COMPACT DISC APPENDIX

Not Applicable

I claim:

1. A liquid vessel comprising:
a container having a closed bottom and an open top, said container forming an internal chamber which can contain a liquid;
a removable lid attached to said container, said lid closing said open top, said lid having a reservoir, said reservoir being exposed to the ambient;
a removable liquid dispensing tube attached to said lid and extending into said internal chamber, said liquid dispensing tube having a lower end and an upper end, said lower end being open to said internal chamber, said upper end being connected to said lid;
a pump means mounted in conjunction with said vessel, activation of said pump means causing pressurized air to flow into said internal chamber which can force liquid in said container to flow through said tube into said reservoir;
said pump means including an air pump located on the lid of said vessel.
